(19) United States
(12) Patent Application Publication
(10) Pub. No.: US 2026/0309963 A1
(43) Pub. Date: Oct. 8, 2026

(54) CAMERA MODULE

(71) Applicant: Samsung Electro-Mechanics Co., Ltd., Suwon-si (KR)

(72) Inventors: Nam Ju LEE, Suwon-si (KR); Bo Sung SEO, Suwon-si (KR); Jae Sung OH, Suwon-si (KR)

(73) Assignee: Samsung Electro-Mechanics Co., Ltd., Suwon-si (KR)

(21) Appl. No.: 19/456,159

(22) Filed: Jan. 22, 2026

(30) Foreign Application Priority Data
Apr. 3, 2025 (KR) 10-2025-0043489

(51) Int. Cl. G02B 13/00; G02B 7/18; G02B 27/10; G02B 27/28; G03B 3/06; G03B 13/34; G03B 17/17; H04N 23/45; H04N 23/54; H04N 23/57; H04N 23/58

(52) U.S. Cl. CPC G02B 13/0065; G02B 7/1805; G02B 27/106; G02B 27/1073; G02B 27/283; G03B 3/06; G03B 13/34; G03B 17/17; H04N 23/45; H04N 23/54; H04N 23/57; H04N 23/58; G03B 2205/0069

(57) ABSTRACT

A camera module includes a first lens unit and a first image sensor disposed along a first optical axis; a second lens unit and a second image sensor disposed along a second optical axis intersecting the first optical axis; and an optical path folding unit disposed between the first lens unit and the first image sensor, wherein the optical path folding unit includes a polarizing member configured to selectively transmit reflect light incident along the first optical axis to the first image sensor or reflect the light incident along the first optical axis to the second image sensor; a first driving unit configured to move the polarizing member in a direction of the first optical axis; and a second driving unit configured to rotate the polarizing member about a rotation axis intersecting the first optical axis and the second optical axis.

### CROSS-REFERENCE TO RELATED APPLICATIONS

This application claims the benefit under 35 USC 119(a) of Korean Patent Application No. 10-2025-0043489 filed on Apr. 3, 2025, in the Korean Intellectual Property Office, the entire disclosure of which is incorporated herein by reference for all purposes.

### BACKGROUND

The present disclosure relates to a camera module including a plurality of image sensors.

Portable electronic devices include a plurality of camera modules configured to selectively capture images of subjects at close range and long range. For example, a portable electronic device includes a close-range imaging camera module and a long-range imaging camera module. However, the portable electronic device may not have enough space to accommodate electronic components, making it difficult to install a plurality of camera modules therein. For example, in order to install a plurality of camera modules in the portable electronic device, there may be a disadvantage in that some functions of the portable electronic device may be reduced or omitted, or the size of the portable electronic device may be increased.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a first lens unit and a first image sensor disposed along a first optical axis; a second lens unit and a second image sensor disposed along a second optical axis intersecting the first optical axis; and an optical path folding unit disposed between the first lens unit and the first image sensor, wherein the optical path folding unit includes a polarizing member configured to selectively transmit light incident along the first optical axis to the first image sensor or reflect the light incident along the first optical axis to the second image sensor; a first driving unit configured to move the polarizing member in a direction of the first optical axis; and a second driving unit configured to rotate the polarizing member about a rotation axis intersecting the first optical axis and the second optical axis.

The camera module may further include a third driving unit configured to move the second lens unit in a direction of the second optical axis.

The camera module may further include a fourth driving unit configured to move the second image sensor in a direction intersecting the second optical axis.

The polarizing member may have a refractive power.

The first driving unit and the second driving unit may include driving magnets and driving coils spaced apart from each other on opposite side surfaces of the polarizing member.

The driving magnets may include a driving magnet in which a first polarity and a second polarity are sequentially arranged in the first optical axis direction, and a driving magnet in which the second polarity and the first polarity are sequentially arranged in the first optical axis direction.

The first driving unit and the second driving unit may include driving magnets and driving coils diagonally disposed relative to each other on opposite side surfaces of the polarizing member.

The driving magnets may include a driving magnet disposed on a first side surface of the polarizing member and having a first polarity and a second polarity sequentially arranged in the first optical axis direction; and a driving magnet disposed on a second side surface of the polarizing member opposite to the first side surface and having the second polarity and the first polarity sequentially arranged in the first optical axis direction.

The second driving unit may include a driving magnet and a driving coil disposed on a first side surface of the polarizing member, and a driving magnet and a driving coil disposed on a second side surface of the polarizing member opposite to the first side surface, and the first driving unit may include a driving magnet and a driving coil disposed on a third side surface of the polarizing member adjacent to the first side surface and the second side surface.

The driving magnet of the first driving unit disposed on the third side surface of the polarizing member may have a first polarity and a second polarity sequentially arranged in a direction of the second optical axis; and the driving magnets of the second driving unit disposed on the first side surface and the second side surface of the polarizing member may have the first polarity and the second polarity sequentially arranged in the first optical axis direction.

The camera module may further include a holder unit supporting the polarizing member, wherein the holder unit may include a first frame coupled to one end of the polarizing member and configured to move in the first optical axis direction; and a second frame coupled to another end of the polarizing member and configured to move in the first optical axis direction.

In another general aspect, a camera module includes a first lens unit and a first image sensor disposed along a first optical axis; a second lens unit disposed along a second optical axis intersecting the first optical axis; a prism disposed on the second optical axis and configured to reflect light refracted through the second lens unit to a third optical axis intersecting the second optical axis; a second image sensor disposed on the third optical axis and configured to convert light reflected from the prism into an electrical signal; and an optical path folding unit disposed between the first lens unit and the first image sensor, wherein the optical path folding unit includes a polarizing member configured to selectively transmit light incident along the first optical axis to the first image sensor or reflect the light incident along the first optical axis to the second image sensor via the prism; a first driving unit configured to move the polarizing member in a direction of the first optical axis; and a second driving unit configured to rotate the polarizing member about a rotation axis intersecting the first optical axis and the second optical axis.

The polarizing member may have a refractive power.

The camera module may further include a third driving unit configured to move the second lens unit in a direction of the second optical axis.

The camera module may further include a fourth driving unit configured to move the prism in a direction intersecting the third optical axis.

The camera module may further include a fourth driving unit configured to move the second image sensor in a direction intersecting the third optical axis.

In another general aspect, a camera module includes a first lens unit and a first image sensor disposed along a first optical axis; a second lens unit and a second image sensor disposed along a second optical axis intersecting the first optical axis; a prism disposed on a third optical axis intersecting the first optical axis and configured to reflect light refracted through the first lens unit to a fourth optical axis intersecting the third optical axis; a third image sensor disposed on the fourth optical axis and configured to convert light reflected from the prism into an electrical signal; and an optical path folding unit disposed between the first lens unit and the first image sensor, wherein the optical path folding unit includes a polarizing member configured to selectively transmit light incident along the first optical axis to the first image sensor, or reflect the light incident along the first optical axis to the second image sensor, or reflect the light incident along the first optical axis to the third image sensor via the prism; a first driving unit configured to move the polarizing member in a direction of the first optical axis; and a second driving unit configured to rotate the polarizing member about a rotation axis intersecting the first optical axis and the second optical axis.

The polarizing member may have a refractive power.

The camera module may further include a third driving unit configured to move the second lens unit in a direction of the second optical axis.

The camera module may further include a fourth driving unit configured to move the second image sensor in a direction intersecting the second optical axis.

Other features and aspects will be apparent from the following detailed description, the drawings, and the claims.

### BRIEF DESCRIPTION OF DRAWINGS

FIG. 1 is a configuration diagram of a camera module according to an embodiment of the present disclosure.

FIG. 2 illustrates an example of a first driving unit and a second driving unit of the camera module of FIG. 1.

FIGS. 3 and 4 illustrate modified embodiments of the first driving unit and the second driving unit of FIG. 2.

FIG. 5 illustrates an embodiment of a holder unit supporting a polarizing member of the camera module of FIG. 1.

FIG. 6 is a configuration diagram of a camera module according to another embodiment of the present disclosure.

FIG. 7 is a configuration diagram of a camera module according to another embodiment of the present disclosure.

FIG. 8 is a configuration diagram of a camera module according to another embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The camera module according to an embodiment of the present disclosure may be mounted on an electronic device. For example, the camera module may be mounted on a portable terminal, laptop, VR device, or glasses. However, electronic devices on which a camera module may be mounted are not limited to the devices described above. As an example, the camera module may be mounted on any portable electronic device, such as a portable game console.

A camera module according to a first embodiment may include a plurality of lens units. For example, a camera module according to the embodiment may include a first lens unit and a second lens unit. The camera module according to the embodiment may include a plurality of image sensors. For example, the camera module according to the embodiment may include a first image sensor and a second image sensor. The camera module according to the embodiment may be configured so that a plurality of lens units and a plurality of image sensors may be disposed along different optical paths. For example, in the camera module according to the embodiment, the first lens unit and the first image sensor may be disposed along a first optical axis, and the second lens unit and the second image sensor may be disposed along a second optical axis. The camera module according to the embodiment may include an optical path folding unit. For example, the camera module according to the embodiment may include an optical path folding unit disposed between the first lens unit and the first image sensor. The optical path folding unit according to the embodiment may include an element selectively transmitting or reflecting light. As an example, the optical path folding unit according to the embodiment may include a polarizing element selectively transmitting light incident along the first optical axis to the first image sensor or reflecting the light to the second image sensor. The optical path folding unit according to the embodiment may include a plurality of driving units for driving the polarizing member. For example, the optical path folding unit according to the embodiment may include a first driving unit configured to move the polarizing member in the first optical axis direction, and a second driving unit configured to rotate the polarizing member about a rotation axis intersecting the first optical axis and the second optical axis.

A camera module according to a second embodiment may include a plurality of lens units. For example, a camera module according to the embodiment may include a first lens unit and a second lens unit. The camera module according to the embodiment may include a plurality of image sensors. For example, the camera module according to the embodiment may include a first image sensor and a second image sensor. The camera module according to the embodiment may be configured so that a plurality of lens units may be disposed along different optical paths. For example, in the camera module according to the embodiment, the first lens unit may be disposed along a first optical axis, and the second lens unit may be disposed along a second optical axis. The camera module according to the embodiment may include an optical path folding unit. For example, the camera module according to the embodiment may include an optical path folding unit disposed between the first lens unit and the first image sensor. The optical path folding unit according to the embodiment may include an element selectively transmitting or reflecting light. As an example, the optical path folding unit according to the embodiment may include a polarizing element selectively transmitting light incident along the first optical axis to the first image sensor or reflecting the light to the second image sensor. The optical path folding unit according to the embodiment may include a plurality of driving units for driving the polarizing member. For example, the optical path folding unit according to the embodiment may include a first driving unit configured to move the polarizing member in the first optical axis direction, and a second driving unit configured to rotate the polarizing member about a rotation axis intersecting the first optical axis and the second optical axis. For example, the camera module according to the embodiment may include a prism reflecting light refracted through the second lens unit to a third optical axis intersecting the second optical axis.

Hereinafter, a camera module according to an embodiment of the present disclosure will be described with reference to the drawings.

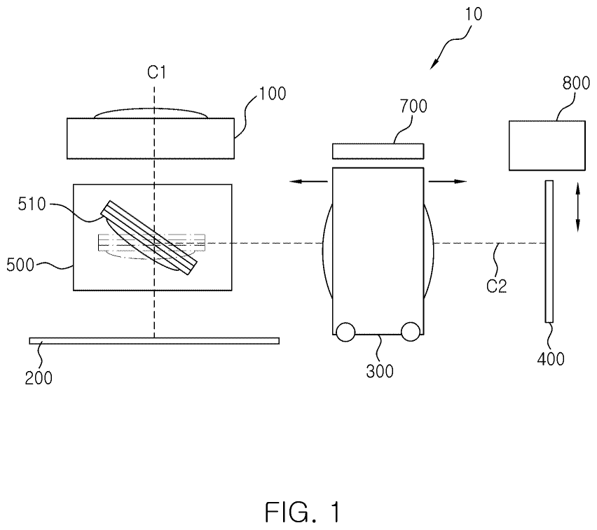

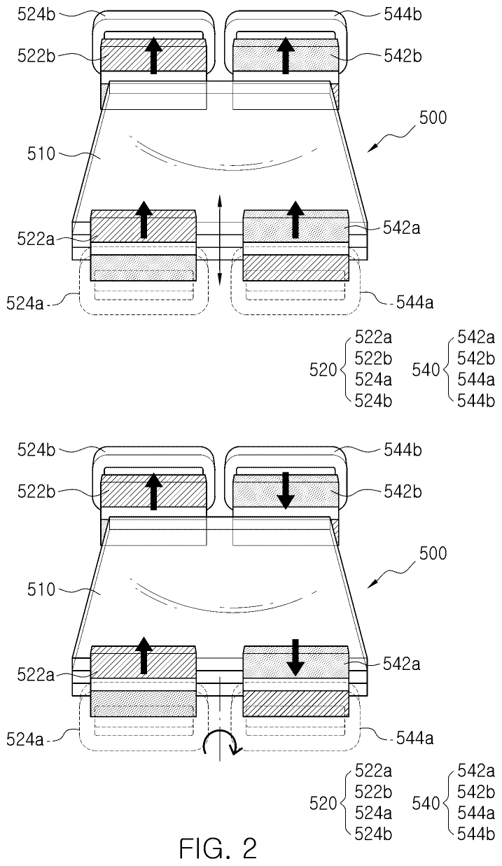

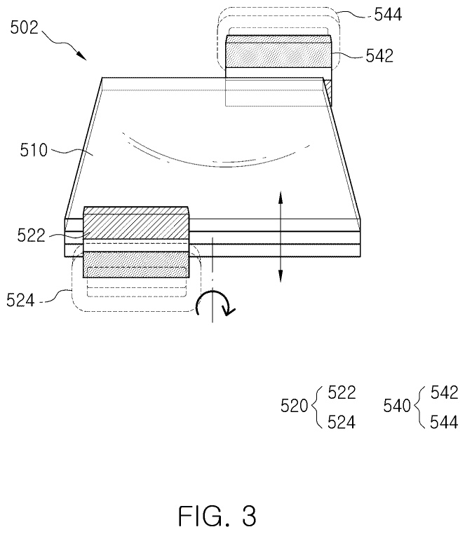

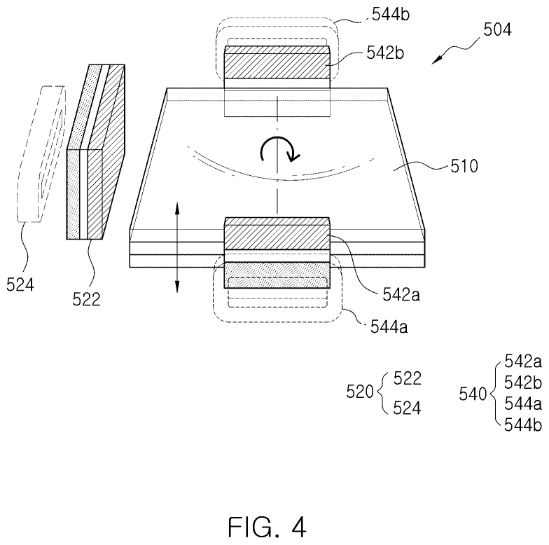

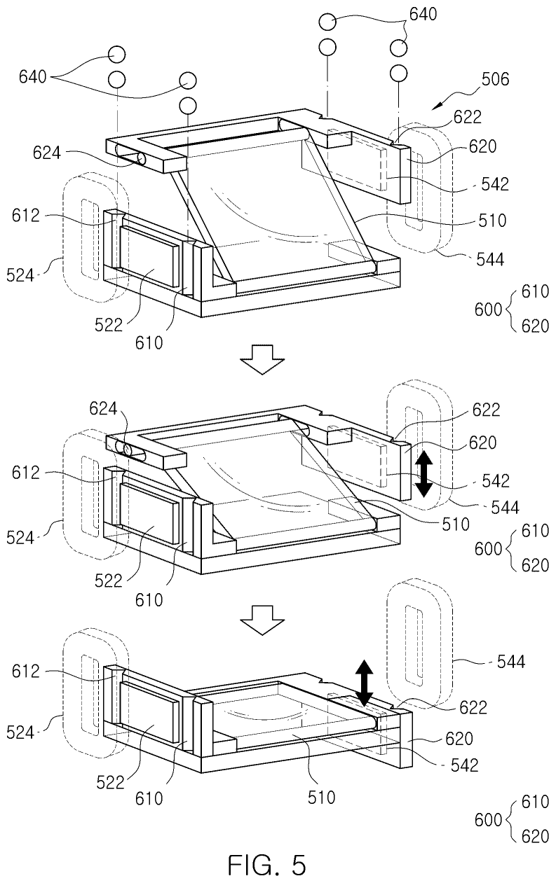

FIG. 1 is a configuration diagram of a camera module according to an embodiment of the present disclosure. FIG. 2 illustrates an embodiment of a first driving unit and a second driving unit of the camera module of FIG. 1. FIGS. 3 and 4 illustrate modified embodiments of the first driving unit and the second driving unit of FIG. 2. FIG. 5 illustrates an embodiment of a holder unit supporting a polarizing member of the camera module of FIG. 1.

Referring to FIG. 1, a camera module 10 according to the present embodiment may include a first lens unit 100, a first image sensor 200, a second lens unit 300, a second image sensor 400, and an optical path folding unit 500. However, the configuration of the camera module 10 is not limited to the above-described members. For example, the camera module 10 may further include a third driving unit 700 and a fourth driving unit 800.

The first lens unit 100 may include a lens having a refractive power. For example, the first lens unit 100 may include one or more lenses disposed along a first optical axis C1. However, a configuration of the first lens unit 100 is not limited to a single lens. For example, the first lens unit 100 may include two or more lenses sequentially disposed along the first optical axis C1.

The first image sensor 200 may be configured to convert an optical signal incident through the first lens unit 100 into an electrical signal. For example, the first image sensor 200 may be disposed along the first optical axis C1 like the first lens unit 100, and may convert light refracted by the first lens unit 100 into an electrical signal.

The second lens unit 300 may include a lens having a refractive power. For example, the second lens unit 300 may include one or more lenses disposed along a second optical axis C2. However, a configuration of the second lens unit 300 is not limited to a single lens. For example, the second lens unit 300 may include two or more lenses disposed sequentially along the second optical axis C2.

The second image sensor 400 may be configured to convert an optical signal incident through the second lens unit 300 into an electrical signal. For example, the second image sensor 400 may be disposed along the second optical axis C2 like the second lens unit 300, and may convert light refracted by the second lens unit 300 into an electrical signal.

The camera module 10 may be configured to enable both close-range and long-range imaging. For example, an optical system including the first lens unit 100 and the first image sensor 200 may be configured to enable close-range imaging, and an optical system including the first lens unit 100, the second lens unit 300, and the second image sensor 400 may be configured to enable long-range imaging. To elaborate, a distance along the first optical axis from a foremost lens of the first lens unit 100 to the first image sensor 200 may be smaller than a distance along the first optical axis and the second optical axis from the foremost lens of the first lens unit 100 to the second image sensor 400.

The optical path folding unit 500 may be disposed between the first lens unit 100 and the first image sensor 200. To elaborate, the optical path folding unit 500 may be disposed at a point at which the first optical axis C1 and the second optical axis C2 intersect in a space between the first lens unit 100 and the first image sensor 200.

The optical path folding unit 500 may be configured to selectively transmit light incident through the first lens unit 100 to the first image sensor 200 or reflect it to the second image sensor 400. To accomplish this, the optical path folding unit 500 may include a polarizing member 510 having a unique shape. The polarizing member 510 may be configured to selectively enable transmission and reflection of light. For example, the polarizing member 510 may be configured to selectively transmit light incident generally in a vertical direction and reflect light incident generally within a range of 40 to 50 degrees. The polarizing member 510 may be configured to have a refractive power. As an example, one surface of the polarizing member 510 (a surface opposing the first image sensor 200) may have a convex shape. As another example, a lens having a refractive power may be attached to the surface of the polarizing member 510 opposing the first image sensor 200.

The optical path folding unit 500 may include a first driving unit 520 and a second driving unit 540 driving a polarizing member 510. For example, the optical path folding unit 500 may include the first driving unit 520 moving the polarizing member 510 in the direction of first optical axis C1, and the second driving unit 540 rotating the polarizing member 510.

Referring to FIGS. 2 to 4, embodiments f the optical path folding unit 500 will be described.

First, an optical path folding unit 500 according to one embodiment will be described with reference to FIG. 2.

The optical path folding unit 500 according to the embodiment may include a first driving unit 520 and second driving unit 540. To elaborate, the first driving unit 520 may include a plurality of driving magnets 522a and 522b, and a plurality of driving coils 524a and 524b as illustrated in FIG. 2. The second driving unit 540 may include a plurality of driving magnets 542a and 542b and a plurality of driving coils 544a and 544b as illustrated in FIG. 2. For example, the first driving unit 520 and the second driving unit 540 may be configured so that the driving magnet 522a and the driving magnet 542a are spaced apart from the driving magnet 542a and the driving coil 544a in a direction of the second optical axis C2 on one side of the polarizing member 510, and the driving magnet 522b and the driving magnet 524b are spaced apart from the driving magnet 542b and the driving coil 544b in the direction of the second optical axis C2 on another side of the polarizing member 51.

The driving magnets 522a and 542a may be disposed in parallel with the driving magnets 522b and 542b in one direction. For example, the driving magnets 522a and 542a may be disposed in parallel with the driving magnets 522b and 542b in the second optical axis C2 direction. The driving magnets 522a and 542a disposed in parallel with the driving magnets 522b and 542b in the second optical axis C2 direction may have a unique configuration. As an example, the driving magnets 522a and 522b may have a first polarity P and a second polarity N sequentially arranged in the first optical axis C1 direction, and the driving magnets 542a and 542b may have the second polarity N and the first polarity P sequentially arranged in the first optical axis C1 direction.

The driving coils 524a, 524b, 544a, and 544b may be disposed facing the driving magnets 522a, 522b, 542a, and 542b, respectively. For example, the driving coils 524a and 544a may face the driving magnets 522a and 542a, respectively, and the driving coils 524b and 544b may face the driving magnets 522b and 542b, respectively. The driving coils 524a and 544a and the driving coils 524b and 544b may be configured so that driving forces in the same direction or in different directions are applied to the polarizing member 510. As an example, the driving coils 524a and 544a and the driving coils 524b and 544b may be configured so that currents flow in different directions so that driving forces in the same direction may be applied to the polarizing member 510 as shown in the top portion of FIG. 2. As another example, the driving coils 524a and 544a and the driving coils 524b and 544b may be configured so that currents flow in the same direction so that driving forces in different directions are applied to the polarizing member 510 as shown in the bottom portion of FIG. 2.

The optical path folding unit 500 configured in this manner may move the polarizing member 510 in the first optical axis C1 direction as shown in the top portion of FIG. 2 or rotate it about a rotation axis intersecting the first optical axis C1 and the second optical axis C2 as shown in the bottom portion of FIG. 2 through magnetic forces generated between the driving magnets 522a, 522b, 542a, and 542b and the driving coils 524a, 524b, 544a, and 544b, respectively.

Next, an optical path folding unit 502 according to another embodiment will be described with reference to FIG. 3.

The optical path folding unit 502 according to the embodiment may include a first driving unit 520 and second driving unit 540. The first driving unit 520 may include a driving magnet 522 and a driving coil 524 as illustrated in FIG. 3, and the second driving unit 540 may include a driving magnet 542 and a driving coil 544 as illustrated in FIG. 3. For example, the first driving unit 520 and the second driving unit 540 may include the driving magnets 522 and 542 and the driving coils 524 and 544 that are disposed on opposite side surfaces of the polarizing member 510 in a diagonal direction.

The driving magnets 522 and 542 may be have a unique configuration. As an example, the driving magnet 522 may have a first polarity P and a second polarity N sequentially arranged in the first optical axis C1 direction, and the driving magnet 542 may have the second polarity N and the first polarity P sequentially arranged in the first optical axis C1 direction.

The driving coils 524 and 544 may face the driving magnets 522 and 542 respectively. For example, the driving coil 524 may face the driving magnet 522, and the driving coil 544 may face the driving magnet 542. The driving coils 524 and 544 may be configured to apply driving forces in the same direction or different directions to the polarizing member 510.

The optical path folding unit 502 configured in this manner may move the polarizing member 510 in the first optical axis C1 direction or rotate it based on a rotation axis intersecting the first optical axis C1 and the second optical axis C2 through the magnetic forces generated between the driving magnets 522 and 542 and the driving coils 524 and 544.

Next, an optical path folding unit 504 according to another embodiment will be described with reference to FIG. 4.

The optical path folding unit 504 according to the embodiment may include a first driving unit 520 and a second driving unit 540 disposed at different positions. For example, the second driving unit 540 may be disposed on a first side surface and a second side surface of the polarizing member 510, and the first driving unit 520 may be disposed on a third side surface of the polarizing member 510. The first driving unit 520 may be disposed adjacent to the second driving unit 540. To elaborate, the second driving unit 540 may include two portions facing each other on opposite side surfaces of the polarizing member 510, and the first driving unit 520 may be disposed on one side surface of the polarizing member 510 adjacent to the two side surfaces of the polarizing member 510 on which the two portions of the second driving unit 540 are disposed.

The first driving unit 520 and the second driving unit 540 may each include at least one driving magnet and at least one driving coil. For example, the first driving unit 520 may include a driving magnet 522 and a driving coil 524, and the second driving unit 540 may include driving magnets 542a and 542b and driving coils 544a and 544b.

The driving magnets 542a and 544b may be disposed on opposite side surfaces of the polarizing member 510. For example, the driving magnets 542a and 542b may be disposed on a first side surface and a second side surface of the polarizing member 510 facing the first side surface, and the driving magnet 522 may be disposed on a third side surface of the polarizing member 510 adjacent to the first side surface and the second side surface. The driving magnets 522, 542a, and 524b may be have a unique configuration. As an example, the driving magnet 522 may have a first polarity P and a second polarity N sequentially arranged in the second optical axis C2 direction, and the driving magnets 542a and 542b may have the first polarity P and the second polarity N sequentially arranged in the first optical axis C1 direction.

The driving coils 524, 544a, and 544b may face the driving magnets 522, 542a, and 542b, respectively. For example, the driving coil 524 may face the driving magnet 522, the driving coil 544a may face the driving magnet 542a, and the driving coil 544b may face the driving magnet 544a.

The optical path folding unit 504 configured in this manner may move the polarizing member 510 in the first optical axis C1 direction as shown in FIG. 4 through a magnetic force generated between the driving magnet 522 and the driving coil 524, and may rotate the polarizing member 510 clockwise or counterclockwise as shown in FIG. 4 through a magnetic force generated between the driving magnet 542a and the driving coil 544a, and a magnetic force generated between the driving magnet 542b and the driving coil 544b.

Referring to FIG. 5, a camera module 10 according to the present embodiment may include an optical path folding unit 506 including a holder unit 600 that enables smooth rotation and movement of the polarizing member 510. The holder unit 600 may include a first frame 610 and a second frame 620. The first frame 610 and the second frame 620 may be coupled to the polarizing member 510. For example, the first frame 610 may be coupled to one end of the polarizing member 510, and the second frame 620 may be coupled to another end of the polarizing member 510.

The first frame 610 and the second frame 620 may be configured to be movable in the first optical axis C1 direction. For example, the first frame 610 and the second frame 620 may move in the first optical axis C1 direction via a ball bearing 640 disposed inside grooves 612 formed in the first frame 610 and side grooves 622 formed in the second frame 620.

The second frame 620 may be configured to move relative to the first frame 610. For example, the second frame 620 may move in a direction away from the first frame 610 or a direction toward the first frame 610. The second frame 620 may be configured to enable movement of the polarizing member 510 in one direction. For example, a guide groove 624 extending in the second optical axis C2 direction may be formed in the second frame 620 to enable the end of the polarizing member coupled to the second frame 620 to move in the second optical axis C2 direction. The second frame 620 configured in this manner may enable rotational movement of the polarizing member 510 through up-and-down movement of the second frame 620 relative to the first frame 610 as illustrated in FIG. 5. For reference, the up-and-down movement of the first frame 610 and the second frame 620 may be performed through driving magnets 522 and 542 and driving coils 524 and 544 configuring a first driving unit 520 and a second driving unit 540.

Referring again to FIG. 1, a third driving unit 700 may be configured to move the second lens unit 300 in the second optical axis C2 direction. For example, the third driving unit 700 may move the second lens unit 300 in a direction toward the optical path folding unit 500 or move the second lens unit 300 in a direction toward the second image sensor 400. The third driving unit 700 may enable autofocusing (AF) of the camera module 10. For example, the third driving unit 700 may enable autofocusing (AF) of a second optical system (telephoto) including the first lens unit 100, the second lens unit 300, and the second image sensor 400 by moving the second lens unit 300 in the second optical axis C2 direction. For reference, although not illustrated in FIG. 1, the third driving unit 700 may be configured to include a driving magnet and a driving coil, similar to the first driving unit 520 and the second driving unit 540.

A fourth driving unit 800 may be configured to move the second image sensor 400 in a direction intersecting the second optical axis C2. The fourth driving unit 800 may enable optical image stabilization (OIS) of the camera module 10 by driving the second image sensor 400 in the direction intersecting the second optical axis C2. For example, the fourth driving unit 800 may enable the optical image stabilization (OIS) of the second optical system (telephoto) including the first lens unit 100, the second lens unit 300, and the second image sensor 400 by moving the second image sensor 400 in the direction intersecting the second optical axis C2.

The camera module 10 configured as described above may enable autofocusing (AF) of a first optical system (wide-angle) including the first lens unit 100 and the first image sensor 200 by moving the polarizing member 510 having a refractive power in the first optical axis C1 direction through the first driving unit 520. Additionally, the camera module 10 according to the present embodiment may selectively configure the first optical system (wide-angle) including the first lens unit 100 and the first image sensor 200 or the second optical system (telephoto) including the first lens unit 100, the second lens unit 300, and the second image sensor 400 by rotating the polarizing member 510 clockwise or counterclockwise through the second driving unit 540. Therefore, the camera module 10 according to the present embodiment may be installed in a limited and narrow space while implementing a plurality of optical systems having different optical characteristics.

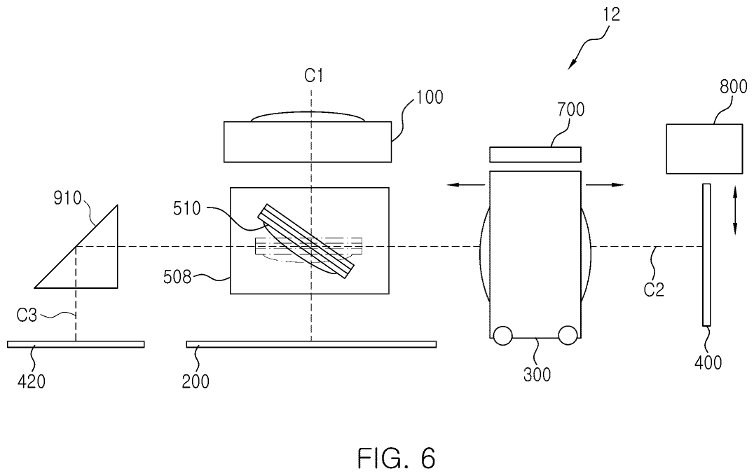

FIG. 6 is a configuration diagram of a camera module according to another embodiment of the present disclosure.

A camera module 12 according to the present embodiment may include the first lens unit 100, the first image sensor 200, the second lens unit 300, the second image sensor 400, and an optical path folding unit 508. However, the configuration of the camera module 12 is not limited to the above-described members. For example, the camera module 12 may further include the third driving unit 700 and the fourth driving unit 800.

The first lens unit 100, the first image sensor 200, the second lens unit 300, the second image sensor 400, the third driving unit 700, and the fourth driving unit 800 are identical to the same elements of the camera module 10 of FIG. 1, so a detailed description of these elements is omitted.

The camera module 12 according to the present embodiment may further include a prism 910 and a third image sensor 420. The prism 910 may be configured to reflect light incident along a third optical axis C3 in a direction of a fourth optical axis C4. The third image sensor 420 may be configured to convert light reflected by the prism 910 into an electrical signal.

The optical path folding unit 508 of the camera module 12 of FIG. 6 is similar to the optical path folding unit 500 of the camera module 10 of claim 1, except that the optical path folding unit 508 is configured to selectively transmit light incident through the first lens unit 100 to the first image sensor 200 along the first optical axis C1, or reflect the light incident through the first lens unit 100 to the second image sensor 400 along the second optical axis C2, or reflect the light incident through the first lens unit 100 to the prism 910 along the third optical axis C3 so that the prism 910 can reflect the light to the fourth image sensor 420 along the fourth optical axis C4.

The camera module 12 configured in this manner may implement three optical systems in one space. For example, the camera module 12 may implement a first optical system including the first lens unit 100, the polarizing member 510 having a refractive power, and the first image sensor 200. Additionally, the camera module 12 may implement a second optical system including the first lens unit 100, the second lens unit 300, and the second image sensor 400. Additionally, the camera module 12 may implement a third optical system including the first lens unit 100 and the third image sensor 420. The first optical system to the third optical system may have different optical characteristics. As an example, the first optical system to the third optical system may have different angles of view. As another example, the first optical system to the third optical system may have different effective focal lengths.

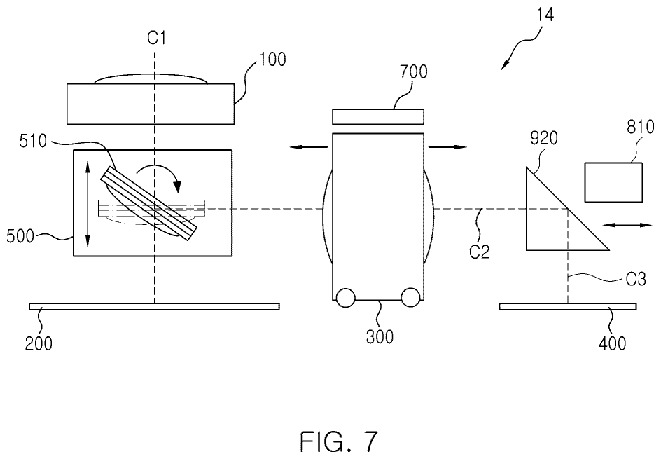

FIG. 7 is a configuration diagram of a camera module according to another embodiment of the present disclosure.

Referring to FIG. 7, a camera module 14 according to the present embodiment may include the first lens unit 100, the first image sensor 200, the second lens unit 300, the second image sensor 400, and the optical path folding unit 500. However, a configuration of the camera module 14 is not limited to the elements described above. For example, the camera module 14 may further include the third driving unit 700, a prism 920, and a fourth driving unit 810.

The first lens unit 100 may include a lens having a refractive power. For example, the first lens unit 100 may include one or more lenses disposed along the first optical axis C1. However, a configuration of the first lens unit 100 is not limited to a single lens. For example, the first lens unit 100 may include two or more lenses sequentially disposed along the first optical axis C1.

The first image sensor 200 may be configured to convert an optical signal incident through the first lens unit 100 into an electrical signal. For example, the first image sensor 200 may be disposed along the first optical axis C1 like the first lens unit 100, and may convert light refracted by the first lens unit 100 into an electrical signal.

The second lens unit 300 may include a lens having a refractive power. For example, the second lens unit 300 may include one or more lenses disposed along the second optical axis C2. However, a configuration of the second lens unit 300 is not limited to a single lens. For example, the second lens unit 300 may include two or more lenses sequentially disposed along the second optical axis C2.

The second image sensor 400 may be configured to convert an optical signal incident through the second lens unit 300 into an electrical signal. For example, the prism 920 may be disposed along the second optical axis C2 like the second lens unit 300 and may reflect light refracted by the second lens unit 300 along a third optical axis C3, and the third image sensor 400 may be disposed along the third optical axis C3 and may convert light refracted by the second lens unit 300 into an electric signal. The second image sensor 400 may be disposed generally parallel to the first image sensor 200. As an example, the second image sensor 400 may be disposed on a same substrate as the first image sensor 200. As another example, the second image sensor 400 may be configured to share some electronic components with the first image sensor 200. As a specific example, the first image sensor 200 and the second image sensor 400 may share passive components.

The camera module 14 may be configured to enable both close-range and long-range imaging. For example, a first optical system including the first lens unit 100 and the first image sensor 200 may be configured to enable close-range imaging, and a second optical system including the first lens unit 100, the second lens unit 300, and the second image sensor 400 may be configured to enable long-range imaging. To elaborate, a distance along the first optical axis C1 from a foremost lens of the first lens unit 100 to the first image sensor 200 may be smaller than a distance along the first optical axis C1, the second optical axis C2, and the third optical axis C3 from the foremost lens of the first lens unit 100 to the second image sensor 400.

The optical path folding unit 500 may be disposed between the first lens unit 100 and the first image sensor 200. To elaborate, the optical path folding unit 500 may be disposed at a point at which the first optical axis C1 and the second optical axis C2 intersect in a space between the first lens unit 100 and the first image sensor 200.

The optical path folding unit 500 may be configured to selectively transmit light incident through the first lens unit 100 to the first image sensor 200 or reflect it to the second image sensor 400. For this purpose, the optical path folding unit 500 may include a polarizing member 510 having a unique configuration. The polarizing member 510 may be configured to selectively allow transmission and reflection of light. For example, the polarizing member 510 may be configured to selectively transmit light incident generally in a vertical direction and reflect light incident generally in a range of 40 to 50 degrees. The polarizing member 510 may be configured to have a refractive power. For example, one surface of the polarizing member 510 (a surface facing the first image sensor 200) may have a convex shape. As another example, a lens having a refractive power may be attached to the surface of the polarizing member 510 facing the first image sensor 200.

The optical path folding unit 500 may include the first driving unit 520 and the second driving unit 540 driving the polarizing member 510. For example, the optical path folding unit 500 may include the first driving unit 520 moving the polarizing member 510 in the first optical axis C1 direction, and the second driving unit 540 rotating the polarizing member 510. The optical path folding unit 500 according to the present embodiment may be identical or similar to any of the optical path folding units 500, 502, 504, and 506 shown in FIGS. 2 to 5.

The third driving unit 700 may be configured to move the second lens unit 300 in the second optical axis C2 direction. For example, the third driving unit 700 may move the second lens unit 300 in a direction toward the optical path folding unit 500 or move the second lens unit 300 in a direction toward the second image sensor 400. The third driving unit 700 may enable autofocusing (AF) of the camera module 14. For example, the third driving unit 700 may enable the autofocusing (AF) of a second optical system (telephoto) including the first lens unit 100, the second lens unit 300, and the second image sensor 400 by moving the second lens unit 300 along the second optical axis C2. For reference, although not illustrated in FIG. 7, the third driving unit 700 may be configured to include a driving magnet and a driving coil similar to the first driving unit 520 and the second driving unit 540 of FIGS. 2-5.

The prism 920 may be configured to reflect light emitted from the second lens unit 300 to the second image sensor 400. The prism 920 may include one or more reflective surfaces. For example, the prism 920 may be a multi-faceted reflector including two reflective surfaces.

The fourth driving unit 810 may be configured to move the prism 920 in a direction intersecting the third optical axis C3. The fourth driving unit 810 may enable optical image stabilization (OIS) of the camera module 14 by driving the prism 920. For example, the fourth driving unit 810 may enable the optical image stabilization (OIS) of the second optical system (telephoto) including the first lens unit 100, the second lens unit 300, the prism 920, and the second image sensor 400 by moving the prism 920 in a direction intersecting the third optical axis C3.

The camera module 14 configured as described above may enable the autofocusing (AF) of an optical system including the first lens unit 100 and the first image sensor 200 by moving the polarizing member 510 having a refractive power in the first optical axis C1 direction through the first driving unit 520. Additionally, the camera module 14 according to the present embodiment may selectively configure a first optical system (wide-angle) including the first lens unit 100 and the first image sensor 200 or a second optical system (telephoto) including the first lens unit 100, the second lens unit 300, the prism 920, and the second image sensor 400 by rotating the polarizing member 510 clockwise or counterclockwise through the second driving unit 540. Therefore, the camera module 14 according to the present embodiment may be installed in a limited and narrow space while implementing a plurality of optical systems having different optical characteristics.

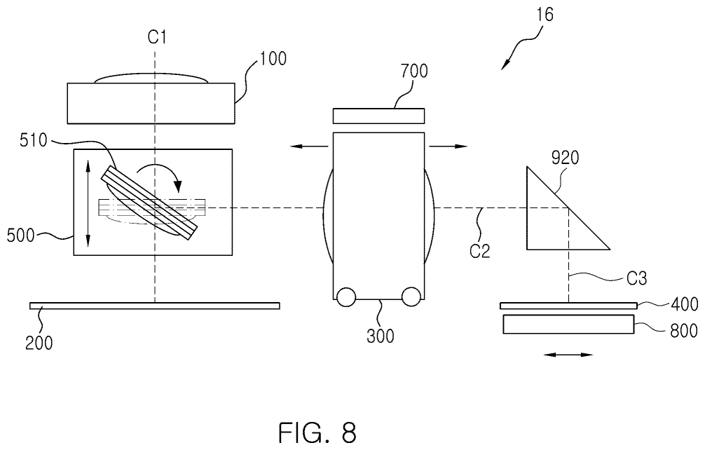

FIG. 8 is a configuration diagram of a camera module according to another embodiment of the present disclosure.

Referring to FIG. 8, a camera module 16 according to the present embodiment may include the first lens unit 100, the first image sensor 200, the second lens unit 300, the second image sensor 400, and the optical path folding unit 500. However, a configuration of the camera module 16 is not limited to the elements described above. For example, the camera module 16 may further include the third driving unit 700, the prism 920, and the fourth driving unit 800.

The first lens unit 100 may include a lens having a refractive power. For example, the first lens unit 100 may include one or more lenses disposed along the first optical axis C1. However, a configuration of the first lens unit 100 is not limited to a single lens. For example, the first lens unit 100 may include two or more lenses sequentially disposed along the first optical axis C1.

The first image sensor 200 may be configured to convert an optical signal incident through the first lens unit 100 into an electrical signal. For example, the first image sensor 200 may be disposed along the first optical axis C1 like the first lens unit 100, and may convert light refracted by the first lens unit 100 into an electrical signal.

The second lens unit 300 may include a lens having a refractive power. For example, the second lens unit 300 may include one or more lenses disposed along the second optical axis C2. However, a configuration of the second lens unit 300 is not limited to a single lens. For example, the second lens unit 300 may include two or more lenses sequentially disposed along the second optical axis C2.

The second image sensor 400 may be configured to convert an optical signal incident through the second lens unit 300 into an electrical signal. For example, the prism 920 may be disposed along the second optical axis C2 like the second lens unit 300 and may reflect light refracted by the second lens unit 300 along a third optical axis C3, and the third image sensor 400 may be disposed along the third optical axis C3 and may convert light refracted by the second lens unit 300 into an electrical signal. The second image sensor 400 may be disposed generally parallel to the first image sensor 200. As an example, the second image sensor 400 may be disposed on a same substrate as the first image sensor 200. As another example, the second image sensor 400 may be configured to share some electronic components with the first image sensor 200. As a specific example, the first image sensor 200 and the second image sensor 400 may share passive components.

The camera module 16 may be configured to enable both close-range and long-range imaging. For example, a first optical system including the first lens unit 100 and the first image sensor 200 may be configured to enable close-range imaging, and a second optical system including the first lens unit 100, the second lens unit 300, and the second image sensor 400 may be configured to enable long-range imaging. To elaborate, a distance along the first optical axis C1 from a foremost lens of the first lens unit 100 to the first image sensor 200 may be smaller than a distance along the first optical axis C1, the second optical axis C2, and the third optical axis C3 from the foremost lens of the first lens unit 100 to the second image sensor 400.

The optical path folding unit 500 may be disposed between the first lens unit 100 and the first image sensor 200. To elaborate, the optical path folding unit 500 may be disposed at a point at which the first optical axis C1 and the second optical axis C2 intersect in a space between the first lens unit 100 and the first image sensor 200.

The optical path folding unit 500 may be configured to selectively transmit light incident through the first lens unit 100 to the first image sensor 200 or reflect it to the second image sensor 400. For this purpose, the optical path folding unit 500 may include a polarizing member 510 having a unique configuration. For example, the polarizing member 510 may be configured to selectively transmit light incident generally in a vertical direction and reflect light incident generally in the range of 40 to 50 degrees. The polarizing member 510 may be configured to have a refractive power. For example, one surface of the polarizing member 510 (a surface facing the first image sensor 200) may have a convex shape. As another example, a lens having a refractive power may be attached to the surface of the polarizing member 510 facing the first image sensor 200.

The optical path folding unit 500 may include the first driving unit 520 and the second driving unit 540 driving the polarizing member 510. For example, the optical path folding unit 500 may include the first driving unit 520 moving the polarizing member 510 in the first optical axis C1 direction and the second driving unit 540 rotating the polarizing member 510. The optical path folding unit 500 according to the present embodiment may be identical or similar to any of the optical path folding units 500, 502, 504, and 506 shown in FIGS. 2 to 5.

The third driving unit 700 may be configured to move the second lens unit 300 in the second optical axis C2 direction. For example, the third driving unit 700 may move the second lens unit 300 in a direction toward the optical path folding unit 500, or move the second lens unit 300 in a direction toward the second image sensor 400. The third driving unit 700 may enable autofocusing (AF) of the camera module 16. For example, the third driving unit 700 may enable the autofocusing (AF) of the second optical system (telephoto) including the first lens unit 100, the second lens unit 300, and the second image sensor 400 by moving the second lens unit 300 in the second optical axis C2 direction. For reference, although not illustrated in FIG. 8, the third driving unit 700 may be configured to include a driving magnet and a driving coil similar to the first driving unit 520 and the second driving unit 540.

The prism 920 may be configured to reflect light emitted from the second lens unit 300 to the second image sensor 400. The prism 920 may include one or more reflective surfaces. For example, the prism 920 may be a multi-faceted reflector having two reflective surfaces.

The fourth driving unit 800 may be configured to move the second image sensor 400 in a direction intersecting the third optical axis C3. The fourth driving unit 800 may enable optical image stabilization (OIS) of the camera module 16 by driving the second image sensor 400. For example, the fourth driving unit 800 may enable the optical image stabilization (OIS) of the second optical system (telephoto) including the first lens unit 100, the second lens unit 300, the prism 920, and the second image sensor 400 by moving the second image sensor 400 in a direction intersecting the third optical axis C3.

The camera module 16 configured as described above may enable the autofocusing (AF) of the first optical system including the first lens unit 100 and the first image sensor 200 by moving the polarizing member 510 having a refractive power in the first optical axis C1 direction through the first driving unit 520. Additionally, the camera module 16 according to the present embodiment may select the first optical system (wide-angle) including the first lens unit 100 and the first image sensor 200 or the second optical system (telephoto) including the first lens unit 100, the second lens unit 300, the prism 920, and the second image sensor 400 by rotating the polarizing member 510 clockwise or counterclockwise through the second driving unit 540. Therefore, the camera module 16 according to the present embodiment may be installed in a limited and narrow space while implementing a plurality of optical systems having different optical characteristics.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a first lens unit and a first image sensor disposed along a first optical axis;
a second lens unit and a second image sensor disposed along a second optical axis intersecting the first optical axis; and
an optical path folding unit disposed between the first lens unit and the first image sensor,
wherein the optical path folding unit comprises:
a polarizing member configured to selectively transmit light incident along the first optical axis to the first image sensor or reflect the light incident along the first optical axis to the second image sensor;
a first driving unit configured to move the polarizing member in a direction of the first optical axis; and
a second driving unit configured to rotate the polarizing member about a rotation axis intersecting the first optical axis and the second optical axis.

2. The camera module of claim 1, further comprising a third driving unit configured to move the second lens unit in a direction of the second optical axis.

3. The camera module of claim 1, further comprising a fourth driving unit configured to move the second image sensor in a direction intersecting the second optical axis.

4. The camera module of claim 1, wherein the polarizing member has a refractive power.

5. The camera module of claim 1, wherein the first driving unit and the second driving unit comprise driving magnets and driving coils spaced apart from each other on opposite side surfaces of the polarizing member.

6. The camera module of claim 5, wherein the driving magnets comprise a driving magnet in which a first polarity and a second polarity are sequentially arranged in the first optical axis direction, and a driving magnet in which the second polarity and the first polarity are sequentially arranged in the first optical axis direction.

7. The camera module of claim 1, wherein the first driving unit and the second driving unit comprise driving magnets and driving coils diagonally disposed relative to each other on opposite side surfaces of the polarizing member.

8. The camera module of claim 7, wherein the driving magnets comprise:
a driving magnet disposed on a first side surface of the polarizing member and having a first polarity and a second polarity sequentially arranged in the first optical axis direction; and
a driving magnet disposed on a second side surface of the polarizing member opposite to the first side surface and having the second polarity and the first polarity sequentially arranged in the first optical axis direction.

9. The camera module of claim 1, wherein the second driving unit comprises a driving magnet and a driving coil disposed on a first side surface of the polarizing member, and a driving magnet and a driving coil disposed on a second side surface of the polarizing member opposite to the first side surface, and
the first driving unit comprises a driving magnet and a driving coil disposed on a third side surface of the polarizing member adjacent to the first side surface and the second side surface.

10. The camera module of claim 9, wherein the driving magnet of the first driving unit disposed on the third side surface of the polarizing member has a first polarity and a second polarity sequentially arranged in a direction of the second optical axis; and
the driving magnets of the second driving unit disposed on the first side surface and the second side surface of the polarizing member have the first polarity and the second polarity sequentially arranged in the first optical axis direction.

11. The camera module of claim 1, further comprising a holder unit supporting the polarizing member,
wherein the holder unit comprises:
a first frame coupled to one end of the polarizing member and configured to move in the first optical axis direction; and
a second frame coupled to another end of the polarizing member and configured to move in the first optical axis direction.

12. A camera module comprising:
a first lens unit and a first image sensor disposed along a first optical axis;
a second lens unit disposed along a second optical axis intersecting the first optical axis;
a prism disposed on the second optical axis and configured to reflect light refracted through the second lens unit to a third optical axis intersecting the second optical axis;
a second image sensor disposed on the third optical axis and configured to convert light reflected from the prism into an electrical signal; and
an optical path folding unit disposed between the first lens unit and the first image sensor,
wherein the optical path folding unit comprises:
a polarizing member configured to selectively transmit light incident along the first optical axis to the first image sensor or reflect the light incident along the first optical axis to the second image sensor via the prism;
a first driving unit configured to move the polarizing member in a direction of the first optical axis; and
a second driving unit configured to rotate the polarizing member about a rotation axis intersecting the first optical axis and the second optical axis.

13. The camera module of claim 12, wherein the polarizing member has a refractive power.

14. The camera module of claim 12, further comprising a third driving unit configured to move the second lens unit in a direction of the second optical axis.

15. The camera module of claim 12, further comprising a fourth driving unit configured to move the prism in a direction intersecting the third optical axis.
16, The camera module of claim 12, further comprising a fourth driving unit configured to move the second image sensor in a direction intersecting the third optical axis.

17. A camera module comprising:
a first lens unit and a first image sensor disposed along a first optical axis;
a second lens unit and a second image sensor disposed along a second optical axis intersecting the first optical axis;
a prism disposed on a third optical axis intersecting the first optical axis and configured to reflect light refracted through the first lens unit to a fourth optical axis intersecting the third optical axis;
a third image sensor disposed on the fourth optical axis and configured to convert light reflected from the prism into an electrical signal; and
an optical path folding unit disposed between the first lens unit and the first image sensor,
wherein the optical path folding unit comprises:
a polarizing member configured to selectively transmit light incident along the first optical axis to the first image sensor, or reflect the light incident along the first optical axis to the second image sensor, or reflect the light incident along the first optical axis to the third image sensor via the prism;
a first driving unit configured to move the polarizing member in a direction of the first optical axis; and
a second driving unit configured to rotate the polarizing member about a rotation axis intersecting the first optical axis and the second optical axis.

18. The camera module of claim 17, wherein the polarizing member has a refractive power.

19. The camera module of claim 17, further comprising a third driving unit configured to move the second lens unit in a direction of the second optical axis.

20. The camera module of claim 17, further comprising a fourth driving unit configured to move the second image sensor in a direction intersecting the second optical axis.
